(19) United States
(12) Patent Application Publication
(10) Pub. No.: US 2008/0218495 A1
(43) Pub. Date: Sep. 11, 2008

(54) CIRCUIT CAPABLE OF SELECTIVELY OPERATING IN EITHER AN INSPECTING MODE OR A DRIVING MODE FOR A DISPLAY

(75) Inventors: Lin LIN, Taichung City (TW); Yi-Chin LIN, Taichung City (TW); Kun-Chang HO, Taichung City (TW); Han-Lun LIN, Zhanghua City (TW); Wen-Chun CHANG, Taichung City (TW); Li-Sheng CHUANG, Dali City (TW)

Correspondence Address: PATENTTM.US, P. O. BOX 82788, PORTLAND, OR, 97282-0788, US

(73) Assignee: WINTEK CORPORATION, Tanzih Hsiang (TW)

(21) Appl. No.: 11/683,860

(22) Filed: Mar. 8, 2007

(51) Int. Cl. G02F 1/133

(52) U.S. Cl. 345/204

(57) ABSTRACT

A circuit capable of selectively operating in an inspecting mode or a driving mode for a display is formed in an integrated circuit and on a glass substrate. The circuit in the IC has a control circuit, a first input circuit, a second input circuit and a fourth input circuit. Each input circuit has a switch. Two additional switches are respectively connected between the first and the second input circuits, and between the second and the fourth input circuits. The glass substrate forms multiple connecting terminals corresponding to the input circuits. Two connecting terminals on the glass substrate are shorted. The control circuit outputs a signal to control all switches to form a configuration suitable for inspecting mode. When inspecting processes are completed, the control circuit changes the configuration for driving mode. The junction resistance of the display is precisely measured and areas in the IC are effectively used.

### BACKGROUND OF THE INVENTION

1. Field of the Invention

The present invention relates to a circuit for a display, and more particularly to a circuit capable of selectively operating in an inspecting mode or a driving mode.

2. Description of Related Art

Comparing with the cathode ray tube (CRT) monitor, LCD display is superior in low driving voltage, low power consumption, low radiation and small volume. Accordingly, LCD display is widely used in video and communication equipment. In addition to the early used of chip on board (COB) and tape carrier bonding (TAB) packaging processes, the package technologies for control chips of the LCD display currently develop to the inner lead bonding (ILB), chip on class (COG) and chip on film (COF).

With reference to FIG. 1, using a COG structure as an example, the COG structure comprises an IC (11), an anisotropic conductive film (ACF) (12) and a glass substrate (13). Multiple gold bumps (111) are formed on the IC (11). Further formed on the glass substrate (13) to correspond to the gold bumps (111) are indium tin oxide electrodes (ITO) (131). The anisotropic conductive film (12) is composed of binder (121) mixed with conductive particles (122) that achieve electronic connection between the gold bumps (111) and the ITO electrodes (131).

As the display ability of LCD develops to high resolution, the number of IC pins and the gold bumps (111) and the density of circuits designed in the IC (11) accordingly increase.

To reduce space the gold bumps (111) occupied, LCD display manufacturers improve the circuit layout designs and shorten the distance between adjacent gold bumps (111). However, when shortening the distance between gold bumps (11), these manufacturers confront some problems.

As shown in FIG. 1, the gold bumps (111) are electroformed on aluminum electrodes (112) through an under bump metallization (UBM) layer (114) and through a protective layer (113). Each aluminum electrode (112) overlaps a part of the adjacent protective layer (113). Because the overlapped regions are thicker than the center non-overlapped portion of the UBM layer (114), a gap with a depth approximates to 1.2 to 2 micrometers accordingly exists. When forming the aluminum electrodes (112), the aluminum electrodes (112) will duplicate the depth of the gap. Therefore, the center portion of the gold bump (111) forms a cavity with a depth of about 2 micrometers.

The often used conductive particles (122) of the anisotropic conductive film (12) have a diameter about 3.5 to 5 micrometers. As the distance between the gold bumps (111) is shortened, fewer conductive particles (122) can contact the gold bumps (111). Furthermore, a short circuit problem may occur at adjacent gold bumps (111) that touch the same conductive particles (122).

Therefore, minimized conductive particles (122) with a diameter smaller than 2 to 3 micrometer are required to meet the reduced distance between the gold bumps (111). However these minimized conductive particles (122) may be easily pushed to the cavity of the gold bumps (111) during the process of connecting the gold bumps (111) of the IC (11) to the ITO electrodes (131) of the glass substrate (13). The failure contact between the gold bumps (111) and the ITO electrodes (131) will significantly affect the electronic performance of the LCD display.

To ensure the product reliability, an impedance measuring method is used to check the connecting status in the junction between the gold bumps of the IC accurately and the ITO electrodes. With reference to FIG. 2, the method uses a multimeter to measure the total impedance (Rₜₒₜₐₗ) of a single close loop. With reference to FIG. 3, the measured total impedance (Rₜₒₜₐₗ) includes the resistance of the ITO layout (R_{ITO-L}), the ITO electrode (113) (R_{ITO}), the conductive particles (122) (R_{ACF}), the gold bumps (111) (R_{G}), the aluminum electrode (112) (R_{A1}) and the aluminum layout (R_{A1-L}), i.e. Rₜₒₜₐₗ=R_{ITO-L}+R_{ITO}+R_{ACF}+R_{G}+R_{A1}+R_{A1-L}+R_{A1}+R_{G}+R_{ACF}+R_{ITO}+R_{ITO-L}. In addition to the desired junction resistance R_{A1}+R_{G}+R_{ACF}+R_{ITO} of FIG. 4, the measured total impedance additionally involves the resistance of the ITO layout (R_{ITO-L}) and the resistance of the aluminum layout (R_{A1-L}) when using the multimeter to measure the total impedance. The measured total impedance value for the single loop can not represent the precise junction resistance. Accordingly, a four-probe testing method is proposed to solve the foregoing problem.

With reference to FIG. 5, the four-probe testing method is applied for the structure composed of an integrated circuit (IC) (20) mounted on a glass substrate (30). The IC (20) has at least one bump group comprising four gold bumps (21), wherein three of them are commonly connected with a wire (23). The glass substrate (30) has multiple electrodes (31) corresponding to the gold bumps (21), wherein two of the electrodes (31) are shorted by another wire (32) and the other two electrodes (31) are open. The anisotropic conductive film (40) between the IC (20) and the glass substrate (30) is composed of binder (41) mixed with conductive particles (42) of small diameter.

The gold bumps (21) of the IC (20) electronically connect to the electrodes (31) of the glass substrate (30) by the conductive particles (42). The binder (41) adheres the IC (20) to the glass substrate (30). The basic concept of the four-probe testing method is based on the equation “R=V/I”, where R is resistance value while V and I respectively represents voltage value and current value. A constant current I is input to one of the two non-shorted electrodes (31), and output from one of the two shorted electrodes (31). A voltage meter is connected between the other two electrodes (31) to measure the voltage value. According to R=V/I, a junction resistance value R can be calculated. Because the method uses a single current loop and a known current source to calculate the voltage value, the junction resistance can be precisely measured.

To obtain the precise junction resistance value, at least four terminals of the IC must be reserved for the four-probe testing. However, after finishing the four-probe testing, these terminals become useless and redundant. For the ICs of high component density, these reserved testing terminals may cause the waste of area in the IC.

### SUMMARY OF THE INVENTION

The objective of the present invention uses the four-probe testing method to measure a junction resistance between a driving IC and a glass substrate of a display module. According to the testing result, the assembling quality of the display module can be precisely monitored. When the testing processes are completed, the testing terminals of the driving IC can be changed for use in a driving mode, i.e. the normal operating mode of the display module. Therefore, the driving IC does not to have additional pins merely for testing purpose so that areas in the IC can be effectively used.

The circuit of the present invention is formed in the driving IC and the glass substrate, wherein the driving IC is mounted on the glass substrate.

The integrated circuit in the driving comprises a control circuit; a first input circuit with a first switch controlled by the control circuit; a second input circuit with a second switch controlled by the control circuit; a fourth input circuit with a third switch controlled by the control circuit; a fourth switch connected between the first input circuit and the second input circuit; a fifth switch connected between the second input circuit and the fourth input circuit; and an inverter connected to the control circuit, wherein the control circuit determines operations of the fourth switch and the fifth switch through the inverter.

The circuit on the glass substrate comprises a control input terminal to be connected to the control circuit of the IC; a first input terminal to be connected to the first input circuit of the IC; a second input terminal to be connected to the second input circuit of the IC; a third input terminal; a fourth input terminal to be connected to the fourth input circuit of the IC; and a wire connected between the second input terminal and the third input terminal.

When the circuit is operated in the inspecting mode, the control input terminal outputs a disable signal such as a low voltage level signal. The disable signal turns off the first switch, the second switch and the third switch. Therefore, there is no signal transmitted to the IC. However, the disable signal, after passing through the inverter, turns on the fourth switch and the fifth switch. Therefore, the first input circuit, the second input circuit and the fourth input circuit are connected together. A circuit configuration for the four-probe testing method is formed.

When the circuit is operated in the driving mode, the control input terminal outputs an enable signal such as a high voltage level signal. The enable signal turns on the first switch, the second switch and the third switch. The enable signal, after passing through the inverter, however turns off the fourth switch and the fifth switch. Therefore, the first input circuit, the second input circuit and the fourth input circuit are separated from each other. External signals can be input to the IC.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional view of a chip on class (COG) structure;

FIG. 2 is a schematic view showing the COG structure of FIG. 1 being tested by an impedance measuring method;

FIG. 3 is a schematic view of a measured total impedance (Rₜₒₜₐₗ) according to 3 the method of FIG. 2;

FIG. 4 is a schematic view of ideal junction impedance in FIG. 2;

FIG. 5 is a schematic view showing the COG structure being tested by a four-probe testing method;

FIG. 6 is a schematic view of a first embodiment of a circuit in accordance with the present invention;

FIG. 7 is a schematic view of the circuit of FIG. 6 operated in a testing mode;

FIG. 8 is a schematic view of the circuit of FIG. 6 operated in a driving mode; and

FIG. 9 is schematic view of a second embodiment of a circuit in accordance with the present invention.

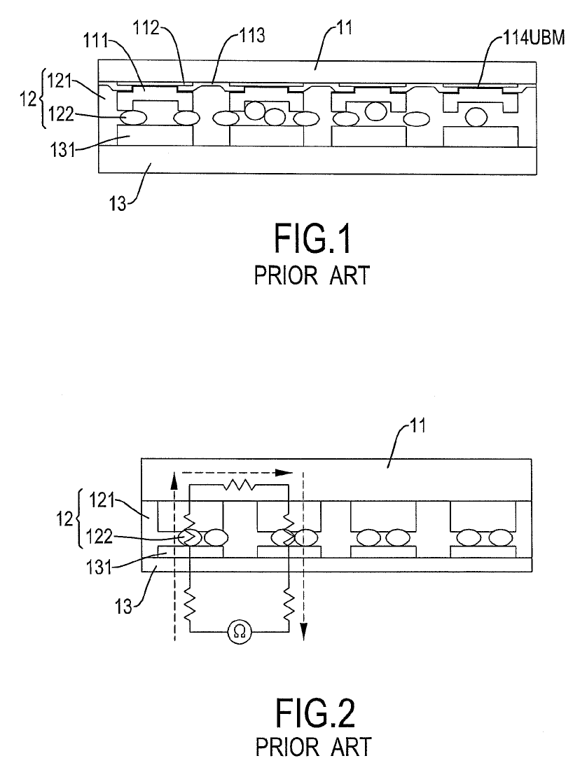

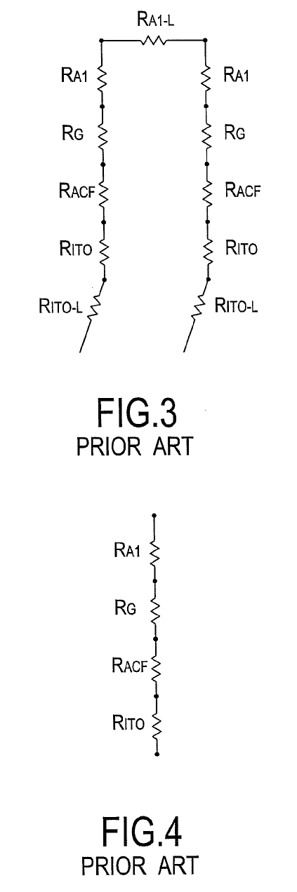

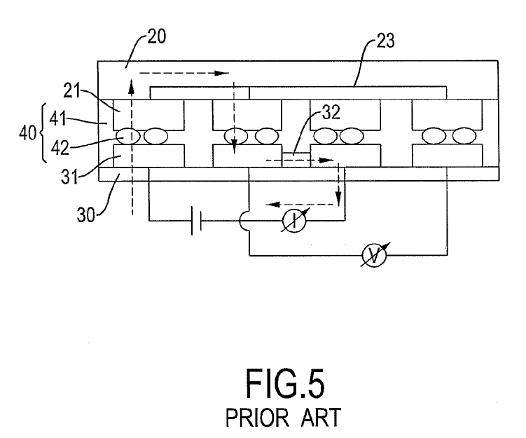

### DETAILED DESCRIPTION OF THE PREFERRED EMBODIMENT

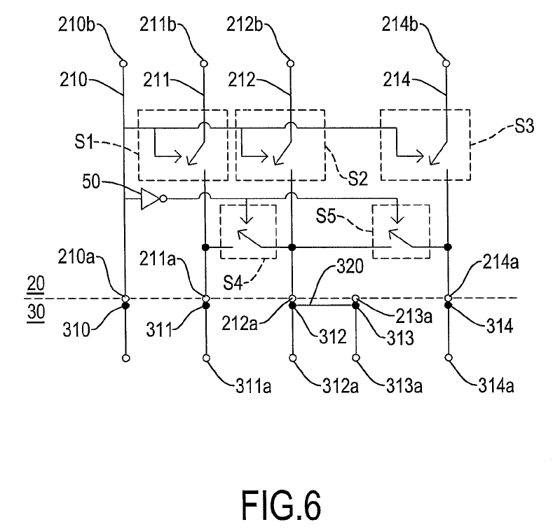

With reference to FIG. 6, a circuit in accordance with the present invention is formed in an integrated circuit (IC) (20) and on a glass substrate (30), wherein the IC (20) is electronically mounted on the glass substrate (30).

The IC (20) comprises a control circuit (210) with a control output terminal (210b) and a connecting terminal (210a).

A first input circuit (211) has a first output terminal (211b) and a first connecting terminal (211a). A first switch (S1) is connected between the two terminals (211a) (211b) of the first input circuit (211), and controlled by the control circuit (210). The control circuit (210) determines whether the first switch (S1) should connect or disconnect the two terminals (211a)(211b) of the first input circuit (211).

A second input circuit (212) has a second output terminal (212b) and a second connecting terminal (212a). A second switch (S2) is connected between the two terminals (212a)(212b) of the second input circuit (212), and controlled by the control circuit (210). The control circuit (210) determines whether the second switch (S2) should connect or disconnect the two terminals (212a) (212b) of the second input circuit (212).

A fourth input circuit (214) has a fourth output terminal (214b) and a fourth connecting terminal (214a). A third switch (S3) is connected between the two terminals (214a) (214b) of the fourth input circuit (214), and controlled by the control circuit (210). The control circuit (210) determines whether the third switch (S3) should connect or disconnect the two terminals (214a) (214b) of the fourth input circuit (214).

A third connecting terminal (213a) is formed at a position between the second connecting terminal (212a) and the fourth connecting terminal (214a).

Furthermore, a fourth switch (S4) is connected between the first input circuit (211) and the second input circuit (212), and a fifth switch (S5) is connected between the second input circuit (212) and the fourth input circuit (214). The control circuit (210), through an inverter (50), controls the fourth switch (S4) and the fifth switch (S5).

The all switches (S1 to S5) can be the N-type metal-oxide-semiconductor (NMOS) elements or P-type (PMOS) elements.

The glass substrate (30) comprises a control input terminal (310), a first input terminal (311), a second input terminal (312), a third input terminal (313) and a fourth input terminal (314). A wire (320) is connected between the second input terminal (312) and the third input terminal (313). When the IC (20) is mounted on the glass substrate (30), the control input terminal (310), the first input terminal (311), the second input terminal (312), the third input terminal (313) and the fourth input terminal (314) are respectively connected to the connecting terminal (210a), the first connecting terminal (211a), the second connecting terminal (212a), the third connecting terminal (213a) and the fourth connecting terminal (214a).

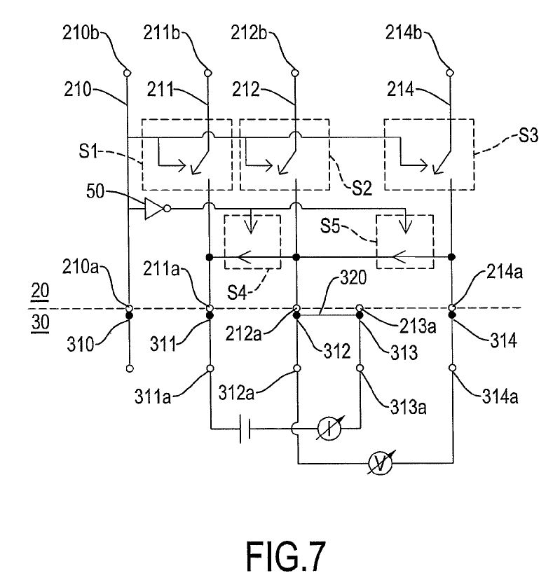

With reference to FIG. 7, when the circuit is operated in the inspecting mode, the control input terminal (310) outputs a disable signal such as a low voltage level signal. The disable signal turns off the first switch (S1), the second switch (S2) and the third switch (S3). Therefore, each of the three paths from the first input terminal (311) to the first out terminal (211b), from the second input terminal (312) to the second output terminal (212b), and from the fourth input terminal (314) to the fourth output terminal (214b) forms a broken circuit. Thus, there is no signal transmitted to the IC (20). However, the disable signal, after passing through the inverter (50), turns on the fourth switch (S4) and the fifth switch (S5). Therefore, the first input circuit (211), the second input circuit (212) and the fourth input circuit (214) are connected together to short the first connecting terminal (211a), the second connecting terminal (212a) and the fourth connecting terminal (214a). A circuit configuration for the four-probe testing method is formed.

In practical application, the control input terminal (310), the first input terminal (311), the second input terminal (312), the third input terminal (313) and the fourth input terminal (314) are respectively connected to the connecting terminal (210a), a first detecting terminal (311a), a second detecting terminal (312a), a third detecting terminal (313a) and a fourth detecting terminal (314a). When the present invention is operated in the inspecting mode, the inspection can be accomplished by shorting three terminals of the IC (20), shorting two input terminals on the glass substrate (30) and opening two input terminals on the glass substrate (30) When using the four-probe testing method, a constant current is input to the first detecting terminal (311a) and output from the third detecting terminal (313a). A voltage meter is coupled between the second detecting terminal (312a) and the fourth detecting terminal (314a) to measure a voltage value. Based on the equation R=V/I, the precise junction resistance can be calculated.

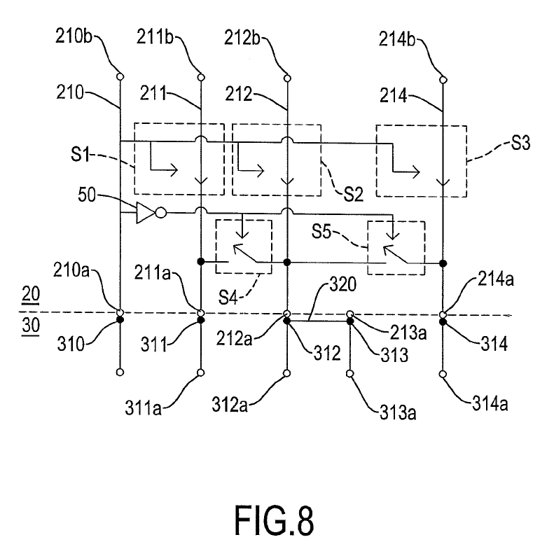

With reference to FIG. 8, when the circuit is operated in the driving mode, the control input terminal (310) outputs an enable signal such as a high voltage level signal. The enable signal turns on the first switch (S1), the second switch (S2) and the third switch (S3). Therefore, each of the three paths from the first input terminal (311) to the first out terminal (211b), from the second input terminal (312) to the second output terminal (212b), and form the fourth input terminal (314) to the fourth output terminal (214b) forms a short circuit. External signals be can input to the IC (20) through the paths. The enable signal, after passing through the inverter (50), however turns off the fourth switch (S4) and the fifth switch (S5). Therefore, the first input circuit (211), the second input circuit (212) and the fourth input circuit (214) are separated from each other. External signals can be input to the IC (20) through the first input terminal (311), the second input terminal (312) and the fourth input terminal (314) on the glass substrate (30).

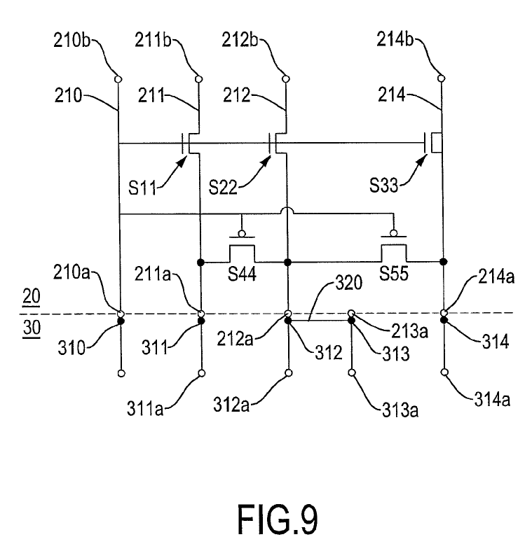

With reference to FIG. 9, in a second embodiment of the present invention the first switch (S11), the second switch (S22) and the third switch (S33) are N-type MOS elements as the controls switches determining whether external signals can be input to the IC (20). The fourth switch (S44) and the fifth switch (S55) are P-type MOS elements as the control switches determining whether the three terminals (211a, 212a and 214a) should be shorted. The second embodiment differs from the first embodiment in that the fourth switch (S44) and the fifth switch (S55) are connected to and controlled by the control circuit (210) without using an inverter (50).

When the circuit of FIG. 9 is operated in the inspecting mode, the control input terminal (310) outputs a disable signal such as a low voltage level signal. The disable signal turns off the first switch (S11), the second switch (S22) and the third switch (S33), but turns on the fourth switch (S44) and the fifth switch (S55). Therefore, inspecting signals will not be input to the IC (20) through the paths of the first switch (S11), the second switch (S22) and the third switch (S33). Because the fourth switch (S44) and the fifth switch (S55) are turned on, the first input circuit (211), the second input circuit (212) and the fourth circuit (214) are connected to short the first connecting terminal (211a), the second connecting terminal (212a) and the fourth connecting terminal (214a). Therefore, the external constant current can be successfully input to the IC (20) to measure a voltage value for calculation of junction resistance.

When the circuit is operated in the driving mode, the control input terminal (310) outputs an enable signal, for example a high voltage level signal to turn on the first switch (S11), the second switch (S22) and the third switch (S33). Therefore, each of the three paths from the first connecting terminal (211a) to the first out terminal (211b), from the second connecting terminal (212a) to the second output terminal (212b), and from the fourth connecting terminal (214a) to the fourth output terminal (214b) forms a conducted circuit. External signals can be transmitted to the IC (20) through the conducted circuits. The enable signal however turns off the fourth switch (S44) and the fifth switch (S55) to separate the first input circuit (211), the second input circuit (212) and the fourth input circuit (214) from each other. Signals can be input to the IC (20) through the first input terminal (311), the second input terminal (312) and the fourth input terminal (314).

In a preferable application according to the present invention, each corner of the IC (20) can be formed as a testing area with three terminals to be shorted for testing. Corresponding to the four testing areas of the IC (20), the glass substrate (30) provides four sets of circuits, wherein each set of the circuits has two terminals to be shorted and two terminals to be opened. The number of the testing areas is not limited to four. However, the IC (20) should have at least one testing area and the glass substrate (30) accordingly should form at least one circuit to correspond to the testing area. Using external probes with a current source, a current meter and a voltage meter, the junction resistance can be precisely detected.

Further, the IC (20) uses five internal elements and an optional inverter (50) to form a configuration that is suitable for use in both of the inspecting mode and the driving mode. Either inspecting mode or the driving mode can be selected depending on different purposes. Since both the inspecting mode and the driving mode use the same input terminals, i.e. the first input terminal (311), the second input terminal (312), and the fourth input terminal (314), these input terminals can be used in the normal operation after testing.

Therefore, when forming a circuit of the present invention in the IC and on the glass substrate, the four-probe testing method can be applied to the circuit for measuring a precise junction resistance to monitor the production quality of the LCD display. After the testing process for the LCD display is completed, the testing terminals can be used as the input/output terminals. The inspecting mode can be switched to the normal driving mode. Thus, the number of pins of the IC can be reduced and the quality of the LCD assembling is ensured.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A circuit capable of selectively operating in either an inspecting mode or a driving mode for a display, the circuit formed in an integrated circuit (IC) and on a glass substrate, the integrated circuit mounted on the glass substrate and comprising:
a control circuit;
a first input circuit with a first switch controlled by the control circuit;
a second input circuit with a second switch controlled by the control circuit;
a fourth input circuit with a third switch controlled by the control circuit;
a fourth switch connected between the first input circuit and the second input circuit;
a fifth switch connected between the second input circuit and the fourth input circuit; and
an inverter connected to the control circuit, the control circuit determining operations of the fourth switch and the fifth switch through the inverter.

2. The circuit as claimed in claim 1, the glass substrate comprising:
a control input terminal to be connected to the control circuit of the IC;
a first input terminal to be connected to the first input circuit of the IC;
a second input terminal to be connected to the second input circuit of the IC;
a third input terminal;
a fourth input terminal to be connected to the fourth input circuit of the IC; and
a wire connected between the second input terminal and the third input terminal.

3. The circuit as claimed in claim 1, wherein the first switch, the second switch, the third switch, the fourth switch and the fifth switch are N-type metal-oxide-semiconductor elements.

4. The circuit as claimed in claim 2, wherein the first switch, the second switch, the third switch, the fourth switch and the fifth switch are N-type metal-oxide-semiconductor elements.

5. The circuit as claimed in claim 1, wherein the first switch, the second switch, the third switch, the fourth switch and the fifth switch are P-type metal-oxide-semiconductor elements.

6. The circuit as claimed in claim 2, wherein the first switch, the second switch, the third switch, the fourth switch and the fifth switch are P-type metal-oxide-semiconductor elements.

7. A circuit capable of selectively operating in either an inspecting mode or a driving mode for a display, the circuit formed in an integrated circuit (IC) and on a glass substrate, the integrated circuit mounted on the glass substrate and comprising:
a control circuit;
a first input circuit with a first switch controlled by the control circuit;
a second input circuit with a second switch controlled by the control circuit;
a fourth input circuit with a third switch controlled by the control circuit;
a fourth switch connected between the first input circuit and the second input circuit; and
a fifth switch connected between the second input circuit and the fourth input circuit, the control circuit controlling operations of the fourth switch and the fifth switch.

8. The circuit as claimed in claim 7, the glass substrate comprising:
a control input terminal to be connected to the control circuit of the IC;
a first input terminal to be connected to the first input circuit of the IC;
a second input terminal to be connected to the second input circuit of the IC;
a third input terminal;
a fourth input terminal to be connected to the fourth input circuit of the IC; and
a wire connected between the second input terminal and the third input terminal.

9. The circuit as claimed in claim 7, wherein the first switch, the second switch and the third switch are N-type metal-oxide-semiconductor elements, and the fourth switch and the fifth switch are P-type metal-oxide-semiconductor elements.

10. The circuit as claimed in claim 8, wherein the first switch, the second switch and the third switch are N-type metal-oxide-semiconductor elements, and the fourth switch and the fifth switch are P-type metal-oxide-semiconductor elements.
